(19) United States
(12) Patent Application Publication
(10) Pub. No.: US 2008/0110411 A1
(43) Pub. Date: May 15, 2008

(54) Self cleaning kennel system

(75) Inventor: Patrick Tracy Cantrell, Greeley, CO (US)

Correspondence Address: CR MILES, P.C.;CRAIG R. MILES, 405 MASON COURT, SUITE 119, FORT COLLINS, CO, 80524, US

(73) Assignee: Modular Concepts Corporation

(21) Appl. No.: 11/985,362

(22) Filed: Nov. 14, 2007

Related U.S. Application Data
(60) Provisional application No. 60/859,127, filed on Nov. 15, 2006.

(51) Int. Cl. A01K 1/02

(52) U.S. Cl. 119/452

(57) ABSTRACT

A self-cleaning kennel which provides a plurality of kennel panels each of which can provide a nozzle coupled to the kennel panel frame which fluidicly couples to a hollow space inside the kennel panel frame to provide a flow path between a liquid source and a nozzle orifice through which an amount of liquid flows to self clean the kennel.

This U.S. Non-provisional patent application claims the benefit of U.S. Provisional Patent Application No. 60/859,127, filed Nov. 15, 2006, hereby incorporated by reference.

### BACKGROUND

A self-cleaning kennel which provides a plurality of kennel panels each of which can provide a nozzle coupled to the kennel panel frame which fluidicly couples to a hollow space inside the kennel panel frame to provide a flow path between a liquid source and a nozzle orifice through which an amount of liquid flows to self clean the kennel.

A variety of kennels or animal enclosures to hold animals have been described including both substantially rigid structures and collapsible structures. See for example U.S. Pat. No. 7,025,019 which describes various collapsible structures suitable to kennel animals.

Typically, kennels or animal enclosures provide a plurality of panels located on a support surface to provide an enclosed space in which the animal may be contained. The enclosure may further include a door in one or more of the panels which operates between a closed condition and an open condition to provide access to the enclosed space. A bottom panel can be joined to the plurality of panels a distance above the support surface to support the contained animal. The bottom panel may further include a plurality of aperture elements which allows animal waste to travel through the apertures from the inside of the enclosed space to the outside of the enclosed space.

A problem common among the various conventional kennels and animal enclosures described is that the kennel surfaces or the support surface on which the kennel has been located may have to be manually cleaned to remove the various materials which may be deposited thereon whether animal waste or otherwise.

Another significant problem with conventional kennels and animal enclosures can be that conduits through which fluids are transferred to provide water to the enclosure, for example water stations, are located such that the animals contained within the kennel or animal enclosure can engage the conduits with various portions of the anatomy such as by clawing, rubbing, chewing, or the like. As a result of engagement of the animal with the conduits, the conduits may be perforated and the fluid transferred within the conduit egresses through the perforation in the conduit.

Another similar problem with conventional kennels and animal enclosures can be that nozzles through which fluids exit the conduits may be located such that the animals contained within the kennel or animal enclosure can engage the nozzles with various portions of the anatomy such as by clawing, rubbing, chewing, or the like. As a result of engagement of the animal with the nozzles, the nozzles may be separated from the conduits which carry the fluids and the fluid transferred within the conduit egresses through the terminal end of the conduit lacking a nozzle or having a damaged nozzle.

### SUMMARY OF THE INVENTION

Accordingly, a broad object of the invention can be to provide a self-cleaning kennel or animal enclosure which provides a conduit to transfer and disperse cleaning fluid to all or a portion of the kennel or animal enclosure surfaces.

Another broad object of the invention can be to provide a self-cleaning kennel or animal enclosure having kennel or enclosure panels which provide one or a plurality of hollow pathway(s) or have a hollow inside in which one or a plurality of conduits which transfer cleaning fluid(s) or water dispersed to all or a portion of the kennel or animal enclosure surface can be located to avoid engagement with the anatomy of an animal contained within the kennel or animal enclosure.

Another broad object of the invention can be to provide a conduit or a plurality of conduits to transfer and disperse cleaning fluid to all or a portion of the kennel or animal enclosure surfaces which have a location within a hollow pathway within the kennel or enclosure panels to avoid engagement with the anatomy of an animal contained within the kennel or animal enclosure.

Another broad object of the invention can be to provide nozzles which disperse cleaning fluid(s) to all or a portion of the kennel or animal enclosure surface located such that the animal contained within the kennel or animal enclosure does not engage the nozzles.

Naturally, further objects of the invention are disclosed throughout other areas of the specification, drawings, photographs, and claims.

### A BRIEF DESCRIPTION OF THE DRAWINGS

FIG. 1 is a perspective view of an embodiment of the inventive self-cleaning enclosure which illustrates a method of self-cleaning an enclosure.

FIG. 2 is a front view of an embodiment of the inventive self-cleaning enclosure.

FIG. 3 is an end view of an embodiment of the inventive self-cleaning enclosure.

FIG. 4 is a top view of an embodiment of the inventive self-cleaning enclosure.

FIG. 5 is a cross section view of the inventive self-cleaning enclosure.

FIG. 6 is a cross section view of the inventive self-cleaning enclosure.

FIG. 7 is a cross section view of a leg of an embodiment of the inventive self-cleaning enclosure which illustrates a fluid conduit and nozzle assembly.

### DETAILED DESCRIPTION OF THE PREFERRED EMBODIMENTS

A self-cleaning kennel which provides a plurality of kennel panels each of which can provide a nozzle coupled to the kennel panel frame which fluidicly couples to a hollow space inside the kennel panel frame to provide a flow path between a liquid source and a nozzle orifice through which an amount of liquid flows to self clean the kennel.

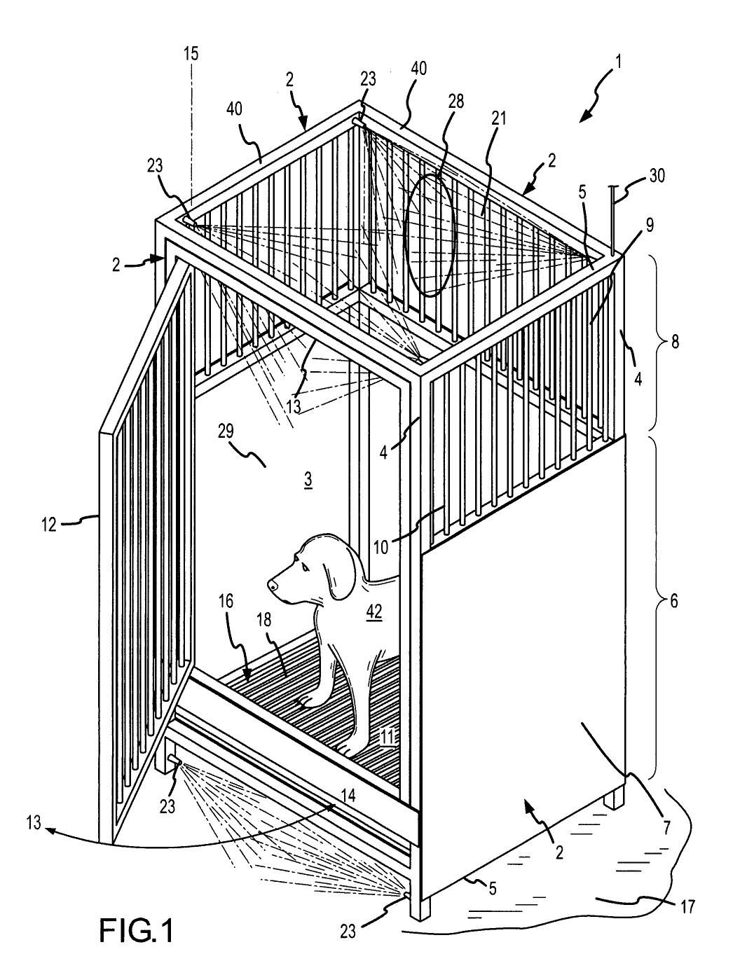

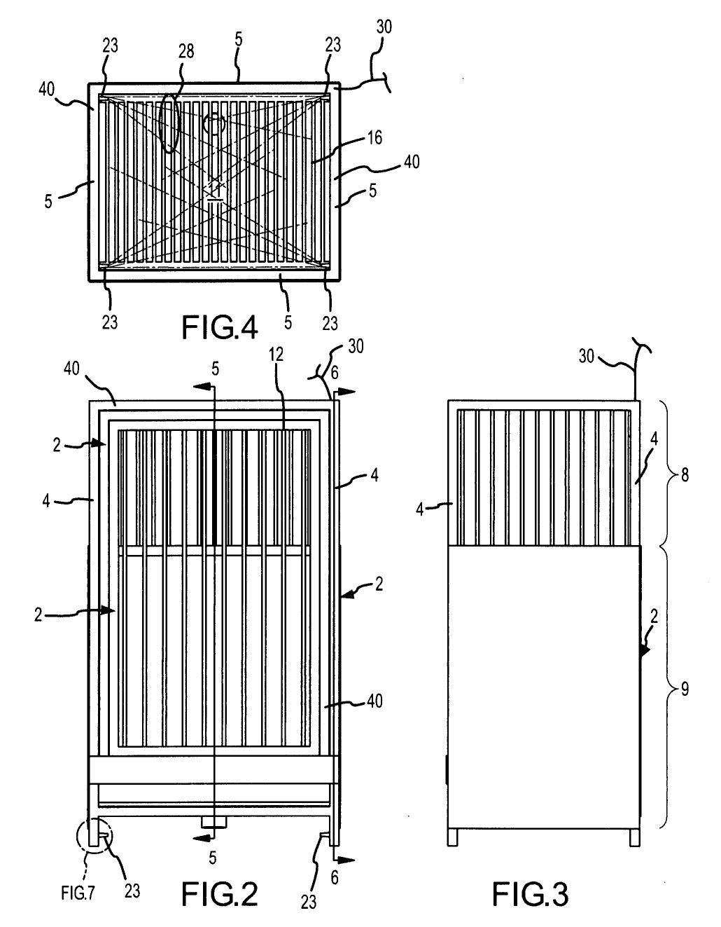

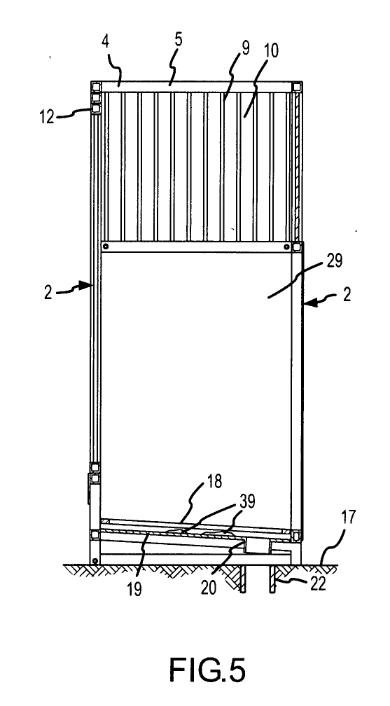

First referring primarily to FIGS. 1-4, an embodiment of the inventive self-cleaning kennel (1) can include a plurality of kennel panels (2) engaged to provide an enclosed space (3). While the plurality of kennel panels (2) shown by FIG. 1-4, each have a square or rectangular constructional form generated by joining a plurality of kennel panel frame members (4)(5) to provide a kennel panel frame (40) (for example by joining a pair of side kennel panel frame members (4) with a pair of end kennel panel frame members (5)), the invention is not so limited and various constructional forms of kennel panels (2) are encompassed by the invention such as kennel panels (2) having arcuate kennel panel frame members (4)(5), or a combination of arcuate and linear kennel panel frame members (4)(5), or the like.

Additionally, while FIG. 1 shows certain of the plurality of kennel panels (2) having a bottom portion (6) having a continuous unbroken panel surface (7) and a top portion (8) having a discontinuous broken panel surface (9)(such as the plurality of vertical rods spaced a distance apart) which afford a plurality of apertures (10), the invention is not so limited and the plurality of kennel panels (2) can be of a constructional form which affords only a continuous unbroken surface (7) or affords only a discontinuous broken surface panel surface (9) which affords the plurality of apertures (10) which communicate from the inside to the outside of the self-cleaning kennel (1) or otherwise in various combinations and permutations. Again, while the embodiment of the inventive self-cleaning kennel shown in FIG. 1 provides a plurality of kennel panels (2) (four in the particular examples shown by the figures) which define the enclosed space (3) having a rectangular area (11), any number of kennel panels (2) can be utilized which can engage to provide the enclosed space (3). The plurality of kennel panels (2) could for example include two kennel panels (2) which engage to provide an enclosed space (3) of a circular area or an oval area or other area configuration.

Again referring primarily to FIGS. 1-4, the inventive self-cleaning kennel (1) can further include an access element (12) coupled to one of the plurality of kennel panels (2) which operates between an open condition (13) and a closed condition (14) to provide access to the enclosed space (3). The access element (12) can have a wide variety of configurations. As to certain embodiments of the self-cleaning animal kennel (1), the access element (12) can comprise substantially the entire area of a kennel panel (2) to which it couples (as shown for example by FIG. 1) and as to other embodiments of the self-cleaning animal kennel (1), the access element (12) may comprise only a portion of the area of kennel panel (2) to which it couples. The access element (12) can be rotatably coupled to the a kennel panel (2) as shown in FIG. 1, or alternately can be a discrete part which releasably engages one of the plurality of kennel panels (2) by the use of a variety of mechanical hardware such as screws, clasps, mateable parts of hook and loop such as VELCRO, eyelets and hooks, or the like, or by interlocking configuration of the access element (12) with the access aperture (13). As to those embodiments of the self-cleaning kennel which rotatably couple the access element (12) to one of the kennel panel sides (2), travel in the access element (12) can be generated about a rotation axis (15) (whether in a vertical or horizontal orientation, or other orientation) to locate the access element (12) at a location between a fully open condition (13) and a fully closed condition (14).

Now referring primarily to FIGS. 1 and 5, the inventive self-cleaning kennel (1) can further include a kennel bottom panel (16) coupled to the plurality of kennel side panels (2). The kennel bottom panel (16) can include a single panel having either a continuous unbroken bottom surface or discontinuous broken bottom surface providing apertures through which animal waste can transfer to the support surface (17). As to the non-limiting embodiment of the inventive self-cleaning kennel (1) shown by FIG. 5, the kennel bottom panel (16) can include a first discontinuous broken surface (18) supported a distance from a second continuous unbroken panel (19). Animal waste (39)(see for example FIG. 5) can pass through the first discontinuous broken surface (18) to collect upon the second continuous unbroken panel (19). An outlet element (20) can be coupled to the second continuous unbroken panel (19) to allow transfer of an amount of liquid (21) and animal waste (39) from the second continuous unbroken panel (20). The outlet element (20) can direct liquids (21) and animal waste (39) to the support surface (17) or to a drain (22).

Referring now primarily to FIG. 1, 6 and 7, the inventive self-cleaning kennel (1) can provide a nozzle (23) which includes a nozzle body (24) having a nozzle body conduit (25) through which an amount liquid (21) can flow and egress from a nozzle orifice (26)(see primarily FIG. 7). The nozzle (23)(or the plurality of nozzles depending upon the embodiment of the self-cleaning kennel (1)) can comprise any of a numerous wide variety of nozzles which as to certain embodiments of the invention can provide a spray adjustment element (27) to configure the spray pattern (28) of the amount of liquid (21) which egresses from the nozzle orifice (26). Adjustment of the spray pattern (28) allows all or a portion of the kennel panel surface (29) to be engaged with the amount of liquid (21). Alternately or in combination with the forgoing, each nozzles (23) (or the plurality of nozzles) can afford a nozzle body (24) directionally adjustable to locate the spray pattern (28) on all or a portion of the kennel panel surfaces (29). One particular embodiment of a nozzle (23) which can be utilized with the various embodiments of the invention described is a three-eights inch nozzle (Part No. 3404K18, McMaster-Carr, P.O. Box 740100, Atlanta, Ga. 30374). However, it is not intended that this example of a nozzle (23) be limiting with respect to utilization of similar, equivalent or any of the numerous and wide variety of nozzles which can perform the functions described herein.

The amount of liquid (21)(or as to certain embodiments an amount of fluid such as a gas, a mixture of gases, or air) can comprise a wide variety of compositions or mixtures under sufficient pressure to exit the nozzle orifice (26) or to generate the spray pattern (28) upon exiting the nozzle orifice (26), including, but not limited to, water, detergents, cleaners, soaps, disinfectants, antibiotics, or the like, individually, in serial or in parallel through a plurality of nozzles, as mixtures, or in various permutations and combinations thereof. As shown by FIG. 1, each nozzle (23) can be located or coupled to one or a plurality of kennel panels (2) such that the nozzle body (24) cannot be engaged by an animal (42) contained within the enclosed space (3) defined by the plurality of kennel panels (2).

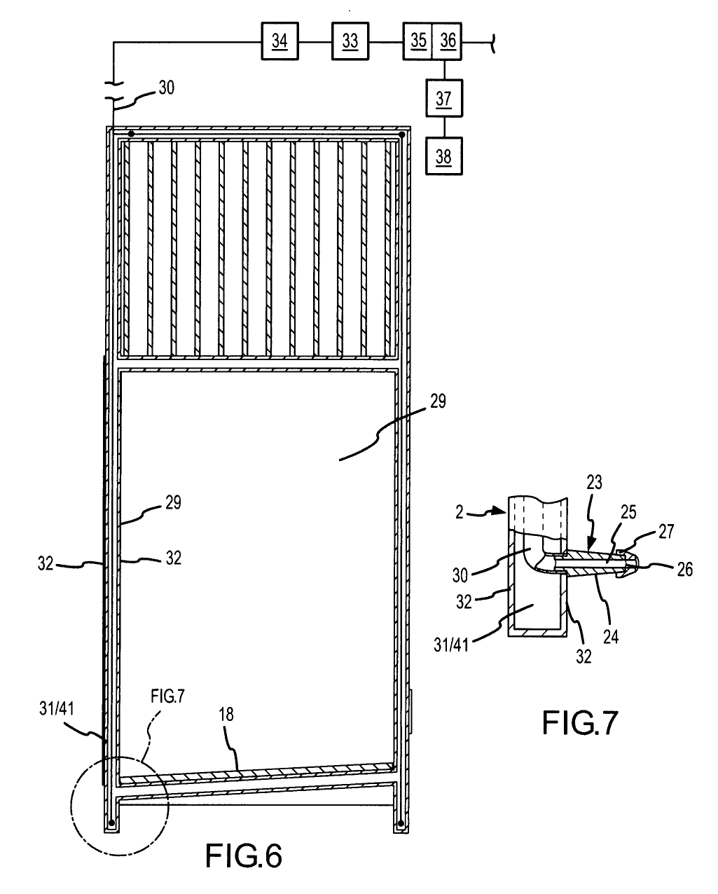

Now referring primarily to FIGS. 6 and 7, each nozzle (23) can be fluidicly coupled to a hollow space (31) inside the kennel panel frame (40) which provides a flow path (whether in whole or in part) in which the amount of liquid (21) can flow between a liquid source ( ) and the nozzle orifice (26). As to these embodiments of the self-cleaning kennel (1), the kennel panel frame (40) or one or more of the kennel panel frame members (4)(5) are provide a tubular constructional form (typically square, rectangular, or circular in cross section) which can be joined to provide the flow path (41) through which an amount of liquid (21) can flow from a liquid source (42) to the nozzle (23)(or plurality of nozzles) without having a discrete conduit coupled to the external surface of the kennel panel (2)(or otherwise having a discrete conduit located external to the plurality of kennel panels (2)).

Again referring primarily to 6 and 7, particular embodiments of the inventive self-cleaning kennel (1) can further provide a conduit (30) which extends within the hollow space (31) inside the kennel panel frame (40) to fluidicly couple the liquid source ( ) to the nozzle orifice (26) through which the amount of fluid (21) can be delivered to the nozzle orifice (26). As but one non-limiting example, the conduit (30) can have an internal diameter of between about one-eighth inch to about one-half inch although for certain applications the internal diameter may be greater or less. The conduit (30) can be produced from a wide variety of materials such as steel, copper, plastic, or the like. As shown in FIG. 6, which provides a cross section view of one of the plurality of kennel panels (2), a portion of one or more of the plurality of kennel panel frame members ( can provide the hollow space (31) in which the conduit (30) can be located.

In the particular embodiment of the inventive self-cleaning kennel (I) shown in FIGS. 1, 3 and 6, the conduit (30) can be routed from a location above the plurality of kennel panels (2) such that the conduit (30) passes into the hollow space (31) of at least one of the kennel panel frames ( ) and can be routed and connected to at least one nozzle (23) coupled to at least one of the kennel side panels (2) as shown in FIG. 7. As shown by FIG. 6, once the conduit (30) passes within one of the plurality of kennel panel frames 0 to the hollow space (31) inside the kennel panel frame (40), the conduit (30) can branch or bifurcate once or a plurality of times to connect the conduit (30) to each of the nozzles (23) coupled to each of the plurality of kennel panels (2) such that the amount of liquid (21) can flow to each of the nozzles (23) as shown for example by FIG. 1. Locating or routing the conduit (30) within the hollow pathway (or hollow space)(3 1) of one or more of the plurality of kennel panel frames (40) places the kennel panel frame side walls (32) between the conduit (30) within the hollow space (31) and any animal 0 contained in the enclosed space (3) of the self-cleaning kennel (1), or any person, or any object which could otherwise engage the conduit (30).

Now referring primarily to FIG. 6, sufficient fluid pressure can be developed in the amount of liquid (21) by the use of one or more of a variety of liquid pressure generators (33) coupled to a suitable pressure regulator (34). The liquid pressure generator (33) can operate to generate an amount of pressure in said flow of said amount of liquid (21) in said flow path.

A valve (35) coupled to the conduit (30) can further include a valve closure (36) which operates from an open condition to a closed condition to correspondingly allow or prevent fluid (21) from flowing in the conduit (30) to the plurality of nozzles (23). The valve closure (36) can be operated between the open condition and the closed condition by a valve closure mechanism (37) which can further be responsive to a timer (38) such that the valve (35) operates automatically to allow or prevent flow of the liquid (21) to the plurality of nozzles (23).

Again referring primarily to FIG. 1, the inventive self cleaning kennel (1) can be utilized by providing a flow of liquid (21) in the hollow space (31) inside the kennel panel frame (40) or inside a conduit (30) which extends within the hollow space (31) inside the kennel panel frame (40). Pressure of the liquid (21) in the hollow space (31) or inside the conduit (30) can be established by adjusting operation of a liquid pressure generator (33) separately or in combination with liquid pressure regulator (34). As to certain embodiments of the inventive self cleaning kennel (1), adjusting each of the plurality of nozzles (23) can allow the spray pattern (28) to be positioned and the configuration of the spray pattern (28) adjusted. The liquid (21) dispersed by each of the plurality of spray nozzles (23) can engage all or a portion of each of the plurality of the kennel panel side surfaces (29) and the kennel bottom panel (16) to animal waste (39) or other materials deposited thereon. The dislocated animal waste (39) or other materials can be entrained by a flow of the liquid (21) and carried through the kennel bottom panel (16) to the support surface (17), or if the kennel bottom panel (16) has a constructional form similar to FIG. 5, carried to the outlet (20) which may be further connect to a drain (22) or storage container.

As can be easily understood from the foregoing, the basic concepts of the present invention may be embodied in a variety of ways. The invention involves numerous and varied embodiments of a self-cleaning kennel enclosure and methods of using such embodiments of the self-cleaning kennel enclosure.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “enclosure” should be understood to encompass disclosure of the act of “enclosing”—whether explicitly discussed or not—and, conversely, were there effectively disclosure of the act of “milling”, such a disclosure should be understood to encompass disclosure of a “enclosure” and even a “means for enclosing.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the self-cleaning enclosures herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims, if any, set forth below are intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A self cleaning kennel, comprising:
a) a plurality of kennel panel frame members joined to provide a kennel panel frame;
b) a hollow space inside said kennel panel frame which provides a flow path for an amount of liquid;
e) a nozzle coupled to said kennel panel frame, wherein said nozzle has a nozzle orifice fluidically coupled to said flow path for said amount of liquid.

2. The self cleaning kennel as described by claim 1, further comprising a kennel panel frame material joined to said kennel panel frame to generate a kennel panel.

3. The self cleaning kennel as described by claim 2, further comprising a kennel generated by joining a plurality of said kennel panel frames to enclose a support surface area, wherein at least one of said plurality of said kennel panel frames have said nozzle which has a nozzle orifice fluidicly coupled to said flow path for said amount of liquid.

4. The self cleaning kennel as described by claim 3, further comprising a conduit which fluidicly couples a liquid source and said continuous hollow space inside said panel frame.

5. The self cleaning kennel as described by claim 4, wherein said conduit extends within said continuous hollow space inside said panel frame to fluidically couple said liquid source to said nozzle orifice.

6. The self cleaning kennel as described by claim 5, wherein a part of said side panel material joined to said side panel has a continuous side panel surface which receives a part of said amount of liquid dispersed by said nozzle orifice.

7. The self cleaning kennel as described by claim 6, further comprising a kennel bottom panel configured to locate inside said kennel joined to said kennel panels at a height above said support surface area.

8. The self cleaning kennel as described by claim 7, wherein said kennel bottom panel has a kennel bottom panel surface coupled to an outlet element, and wherein said kennel bottom panel surface receives said amount of liquid dispersed by said nozzle orifice, and wherein said kennel bottom panel has a configuration which generates travel of said amount of liquid received to said outlet element.

9. The self cleaning kennel as described by claim 8, further comprising a valve which operates between an open condition and a closed condition to regulate a flow of said amount of liquid in said flow path between said liquid source and said nozzle orifice.

10. The self cleaning kennel as described by claim 9, further comprising a liquid pressure generator which operates to generate an amount of pressure in said flow of said amount of liquid in said flow path.

11. The self cleaning kennel as described by claim 10, further comprising a pressure regulator which operates to adjust pressure in said flow of said amount of liquid in said flow path.

12. The self cleaning kennel as described by claim 11, further comprising a timer which establishes an interval of time in which said valve remains in the open condition and the closed condition to regulate a flow of said amount of liquid in said flow path between said liquid source and said nozzle orifice

13. A method of producing a self cleaning a kennel, comprising the steps of:
a) providing a plurality of kennel panel frame members;
b) joining said plurality of kennel panel frame members to generate a kennel panel frame;
c) generating a hollow space inside said kennel panel frame;
d) establishing a flow path for an amount of liquid within said hollow space inside said kennel panel frame;
e) coupling a nozzle to at least one of said plurality of kennel panel frame members joined to generate said kennel panel frame; and
f) fluidically coupling a nozzle orifice to said continuous hollow space inside said kennel panel frame member which provides said flow path for said amount of liquid.

14. The method of producing a self cleaning a kennel as described by claim 13, further comprising the step of coupling a kennel panel material to said kennel panel frame to generate a kennel panel.

15. The method of producing a self cleaning a kennel as described by claim 14, further comprising the step of engaging a plurality of said kennel panels to enclose a support surface area.

16. The method of producing a self cleaning a kennel as described by claim 15, further comprising the steps of providing a kennel bottom panel having an outlet element and engaging said kennel bottom panel with said plurality of said kennel panels to locate said kennel bottom pane a height above said enclosed support surface area.

17. The method of producing a self cleaning a kennel as described by claim 16, further comprising the step of fluidicly coupling a liquid source to said nozzle orifice.

18. The method of producing a self cleaning a kennel as described by claim 17, wherein said step of fluidicly coupling a liquid source to said nozzle orifice comprises fluidically coupling a conduit flow path of a conduit between said liquid source and said hollow space inside of said kennel panel frame.

19. The method of producing a self cleaning a kennel as described by claim 18, wherein said step of fluidicly coupling a liquid source to said nozzle orifice further comprises extending said conduit through said hollow space inside said kennel panel frame to connect to said nozzle.

20. The method of producing a self cleaning a kennel as described by claim 19, further comprising the step of coupling a valve to said conduit which operates between an open condition and a closed condition to provide an open condition of said flow path and a closed condition of said flow path.

21. The method of producing a self cleaning a kennel as described by claim 20, further comprising the step of providing a liquid pressure generator which operates to generate pressure in said amount of liquid in said flow path of said conduit.

22. The method of producing a self cleaning a kennel as described by claim 21, further comprising the step of providing a liquid pressure regulator which operates to adjust pressure of said amount of liquid in said conduit.

23. The method of producing a self cleaning a kennel as described by claim 21, further comprising the step of providing a timer which operates to establish an interval in which said valve remains in the open condition.

24-30. (canceled)
